(19) United States
(12) Patent Application Publication
(10) Pub. No.: US 2003/0034458 A1
(43) Pub. Date: Feb. 20, 2003

(54) Radiation image storage panel

(75) Inventors: Yuji Isoda, Kanagawa (JP); Makoto Kashiwaya, Kanagawa (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/109,842

(22) Filed: Apr. 1, 2002

(30) Foreign Application Priority Data
Mar. 30, 2001 (JP) 2001-102221
Jul. 10, 2001 (JP) 2001-209452

(51) Int. Cl. G03B 42/08

(52) U.S. Cl. 250/484.4; 250/584; 427/65

(57) ABSTRACT

A radiation image storage panel composed of a substrate and a phosphor film of an europium activated cesium bromide phosphor containing an europium element at an atomic ratio in the range of 0.0001 to 0.01 in terms of Eu/Cs and having been formed by vapor deposition shows specifically high sensitivity. The phosphor film is favorably deposited on the substrate by electron beam-evaporation method using plural evaporation sources.

### FIELD OF THE INVENTION

The preset invention relates to a radiation image storage panel favorably emloyable in a radiation image recording and reproducing method utilizing stimulated emission of a stimulable phosphor.

### BACKGROUND OF THE INVENTION

When the stimulable phosphor is exposed to radiation such as X-rays, it absorbs and stores a portion of the radiation energy. The stimulable phosphor then emits stimulated emission according to the level of the stored energy when the Phosphor is exposed to electromagnetic wave such as visible light or infrared rays (i.e., stimulating light).

A radiation image recording reproducing method utilizing the stimulable phosphor has been widely employed in practice. The method employs a radiation image storage panel comprising the stimulable phosphor, and comprises the steps of causing the stimulable phosphor of the storage panel to absorb radiation energy having passed through an object or having radiated from an object; sequentially exciting the stimulable phosphor with a stimulating light to emit stimulated light; and photo-electrically detecting the emitted light to obtain electric signals giving a visible radiation image. The storage panel thus treated is subjected to a step for erasing radiation energy remaining therein, and then stored for the use in the next recording and reproducing procedure. Thus, the radiation image storage panel can be repeatedly used.

The radiation image storage panel (often referred to as stimulable phosphor sheet) has a basic structure comprising a substrate and a stimulable phosphor layer provided thereon.

The phosphor layer is generally formed by coating a dispersion of phosphor particles in a binder solution on the substrate and the coated dispersion on the substrate, and therefore uses a binder and phosphor particles dispersed therein.

It is desired that radiation image storage panels used in these methods have sensitivity as high as possible.

It is known that a radiation image storage panel having on a substrate a stimulable phosphor film prepared by vapor deposition (or vapor-accumulating method) such as vacuum vapor deposition or sputtering gives a reproduced radiation image with high sensitivity as well as high sharpness.

Japanese Patent Provisional Publication No. 62-47600 discloses a method in which a stimulable phosphor film of a radiation image storage panel is formed by electron beam evaporation (which is a kind of vapor deposition method). In the method, an electro beam generated by an electron gun is applied onto a stimulable phosphor or its starting materials (i.e., evaporation source) to heat and vaporize the source, to deposit the vapor on the surface of the substrate. Thus formed phosphor film consists of prismatic crystals of the stimulable phosphor. Thus, a phosphor film formed by vapor deposition comprises only a stimulable phosphor with no binder, and in the phosphor film there are cracks among the prismatic crystals of the stimulable phosphor. For this reason, the stimulating rays are efficiently applied to the phosphor and the stimulated emission are also efficiently taken out. Hence, a radiation image of high sharpness can be obtained with high sensitivity.

Japanese Patent Publication No. 6-77079 describes a radiation image storage panel in which a stimulable phosphor film is formed by vapor deposition to have a fine block structure. A wide variety of stimulable phosphors are described in the publication as phosphors emloyable in the storage panel. However, only thallium activated rubidium bromide phosphors are mentioned in detail in the publication.

Japanese Patent Publication No. 6-100679 describes a radiation image storage panel comprising a phosphor film of thallium activated rubidium halide which is prepared by heating plural evaporation sources with controlling evaporation rates of these evaporation sources.

Japanese Patent Publication No. 7-84588 describes a radiation image storage panel having a stimulable phosphor layer using an alkali metal (Rb or Cs) halide phosphor. In the publication, the phosphor film is produced by coating a phosphor-binder dispersion on a support. The alkali metal halide is defined to contain an activator element of not more than 20 atomic %.

Japanese Patent Publication No. 5-32945 describes an apparatus for a radiation image-reproducing process comprising the steps of exposing a radiation image storage panel to stimulating rays having emitted from a light source (e.g., a fluorescent lamp) through a slit for linearly stimulating the radiation image storage panel (i.e., line stimulation), and detecting the stimulated emission having emitted from the storage panel by a line sensor comprising many photoelectric converting elements (i.e., line detection). The line sensor is placed so that it can face the storage panel in the area exposed to the stimulating rays on the exposed side or its back side.

### SUMMARY OF THE INVENTION

The present invention has an object to provide a radiation image storage panel which shows specifically high sensitivity.

The present inventors have studied a vapor deposited film of a stimulable europium activated alkali metal halide, particularly, a deposited stimulable europium activated cesium bromide phosphor film, to find out the conditions under which stimulated emission is produced with high luminance. As a result, they have discovered that the europium activated alkali metal halide phosphor film shows high sensitivity when the europium activator is contained in the phosphor composition in an amount of a specific range.

Further, they have discovered that a stimulable phosphor film such as an europium activated alkali metal halide phosphor film is prominently uniformly deposited on a substrate when plural metal elements of the phosphor are divided into plural portions and these plural portions are evaporated individually by vapor deposition, particularly, electron beam deposition.

Furthermore, they have found that a radiation image storage panel having a phosphor of an alkali metal halide activated by a specific amount of europium is very favorably employable in a radiation image-reproducing method utilizing the combination of line-stimulation and line-detection.

They have furthermore found that a combined pellet comprising two metal-containing compounds for stimulable phosphor, for example, a mother component compound and an activator component compound can be satisfactorily employed for vapor-depositing various stimulable phosphors to form stimulable phosphor films.

Accordingly, the present invention resides in a radiation image storage panel comprising a substrate and a phosphor film which has cracks extending in a depth direction thereof and is formed by vapor deposition, wherein the phosphor film comprises an europium activated alkali metal halide phosphor hang the formula (I):

M^{I}X.bM^{II}X′₂.cM^{III}X″₃:zEu (I)

in which M^{I} is at least one alkali metal element selected from the group consisting of Cs, Li, Na, K and Rb; M^{II} is at least one alkaline earth metal element or divalent metal element selected from the group consisting of Be, Mg, Ca, Sr, Ba, Ni, Cu, Zn and Cd; M^{III} is at least one rare earth element or trivalent metal element selected from the group consisting of Sc, Y, La, Ce, Pr, Nd, Pm, Sm, Eu, Gd, Tb, Dy, Ho, Er, Tm, Yb, Lu, Al, Ga and In; each of X, X′ and X″ independently is at least one halogen selected from the group consisting of F, Cl, Br and I; and a, b, c and z are numbers satisfying the conditions of 0≦b≦0.5, 0≦c≦0.5 and 0.0001≦z≦0.01, respectively.

In the formula (I), z preferably satisfies the condition of 0.0005≦z≦0.007, more preferably 0.001≦z≦0.007, particularly preferably 0.003≦z≦0.005.

The invention further resides in a radiation image storage panel comprising a substrate and a phosphor film which has cracks extending in a depth direction thereof and is formed by vapor deposition, wherein the phosphor film comprises an europium activated cesium bromide phosphor having the formula (II):

CsBr.aM^{I}X.bM^{II}X′₂.cM^{III}X″₃:zEu (II)

in which M^{I} is at least one alkali metal element selected from the up consisting of Li, Na, K and Rb; M^{II} is at least one alkaline earth metal element or divalent metal element selected from the group consisting of Be, Mg, Ca, Sr, Ba, Ni, Cu, Zn and Cd; M^{III} is at least one rare earth element or trivalent metal element selected from the group consisting of Sc, Y, La, Ce, Pr, Nd, Pm, Sm, Eu, Gd, Tb, Dy, Ho, Er, Tm, Yb, Lu, Al, Ga and In; each of X, X′ and X″ independently is at least one halogen selected from the group consisting of F, Cl, Br and I; and a, b, c and z are numbers satisfying the conditions of 0≦a≦0.5, 0≦b≦0.5, 0≦c≦0.5 and 0.0001≦z≦0.01, respectively.

In the formula (II), z preferably satisfies the condition of 0.0005≦z≦0.007, more preferably 0.001≦z≦0.007, particularly preferably 0.003≦z≦0.005.

The invention furthermore resides in a radiation image storage panel comprising a substrate and a phosphor film which has cracks extending in a depth direction thereof and is formed by vapor deposition, wherein the phosphor film comprises an europium activated cesium bromide phosphor containing an europium element at an atomic ratio in the range of 0.0001 to 0.01 in terms of Eu/Cs.

The atomic ratio preferably is in the range of 0.0005 to 0.007, more preferably 0.001 to 0.007, most preferably 0.003 to 0.005.

The radiation image storage panel of the invention is preferably covered with a protective film showing a moisture permeability (at 25° C.) of not higher than 300 g/m²·24 hr·μm.

The invention furthermore resides in a process for reading radiation image information comprising the steps of:

moving in one direction the radiation image storage panel of the invention on which radiation image information is recorded and stored, in relation to a line sensor which comprises plural photoelectric converting elements arranged linearly and which is placed over the convex surfaces of the aligned prismatic phosphors of the storage panel on a line extending from the end of the convex surface of the aligned prismatic crystal in the same direction, under such condition that the line sensor moves on a plane parallel to the storage panel, while the phosphor film of the storage panel is scanned with stimulating rays in a direction which is different from the direction of the movement of the storage panel and the stimulating lays are applied onto the phosphor film approximately parallel to the aligning direction of the prismatic phosphor crystals in the phosphor film;

detecting an emission emitting from the phosphor film of the storage panel by the line sensor, so as to photoelectrically convert the emission to an electric signal;

detecting an electric signal of the movement of the storage panel in relation to the line sensor; and

comparing the signal of the emission and the signal of the movement of the storage panel to produce a radiation image information in the form of electric signals.

The vapor deposition is preferably performed by heating an evaporation source of the phosphor with an electron beam. The evaporation source is preferably divided into plural evaporation source portions, one of which comprises an europium compound and other of which comprises a cesium compound. It is preferred that the plural evaporation source portions are placed adjacently to each other forming one unit.

The invention furthermore resides in a method for forming on a substrate a phosphor film of a stimulable phosphor comprising a mother component and an activator component by vapor deposition utilizing plural evaporation source portions one of which comprises the activator component source and other of which comprises a mother component source and which are placed adjacently to each other forming one unit.

The invention furthermore resides in a method for forming on a substrate a phosphor film of a stimulable phosphor comprising at least two metal elements by vapor deposition utilizing plural evaporation source portions one of which comprises one metal element source and other of which comprises other metal source and which are placed adjacently to each other forming one unit.

In both of the phosphor film-forming method, the vapor deposition is preferably performed by heating the evaporation since portions of the phosphor with an electron beam.

### BRIEF DESCRIPTION OF DRAWINGS

FIG. 1 indicates an apparatus for reproducing radiation image from a radiation image storage panel utilizing the line stimulation-line detection.

FIG. 2 indicates a section of the apparatus of FIG. 1 taken along I-I line.

FIG. 3 is a graph indicating a relationship between the europium concentration of CsBr:Eu phosphor and luminance of stimulated emission.

Each of FIGS. 4 to 6 indicates an exemplary constitution of a pellet of evaporation source in which two evaporation source comments are divided.

FIG. 7 indicates an evaporation source which is divided into two portions and placed individually in a dish having two spaces.

FIG. 8 indicates a conventional evaporation source pellet.

### DETAILED DESCRIPTION OF THE INVENTION

The preparation of a radiation image storage panel of the invention is described below by referring to the case of employing the stimulable CsBr:Eu phosphor.

The radiation image storage panel comprises a substrate and a phosphor film deposited on the substrate. The substrate can be selected from those employed in the conventional radiation image storage panels. The substrate preferably are sheets of quartz glass, metals (e.g., aluminum, iron, tin, chromium) and heat-resistant resins (e.g., aramide).

On the substrate, the phosphor film is deposited. The phosphor film is preferably formed by electron beam deposition which employs electron beam to heat the evaporation source. The electron beam evaporation gives regularly aligned prismatic crystals having good shape.

The evaporation source comprises an europium-containing cesium bromide or a set of components forming the europium activated cesium bromide. A small amount of a metal oxide compound such as aluminum oxide, silicon dioxide, or zirconium oxide can be incorporated into the evaporation source.

The evaporation source is preferably divided into plural portions having plural metal components of which the phosphor is composed. It is preferred that the plural metal components have different vapor pressure. For instance, it is preferred that the temperature difference at which a vapor pressure of 1.333 Pa is not higher than 700° C. between two metal components. That is, for instance, a mother component such as CsBr, and an activator component such as an europium compound. The europium compound preferably is an europium halide or oxide. Europium bromide (EuBrₓ in which x is from 2.0 to 2.3) is most preferred.

Generally, the europium compound comprises a divalent europium (Eu²⁺) compound and a trivalent (Eu³⁺) compound. It is preferred that the europium compound contains the divalent europium compound as such as possible, at least 70%.

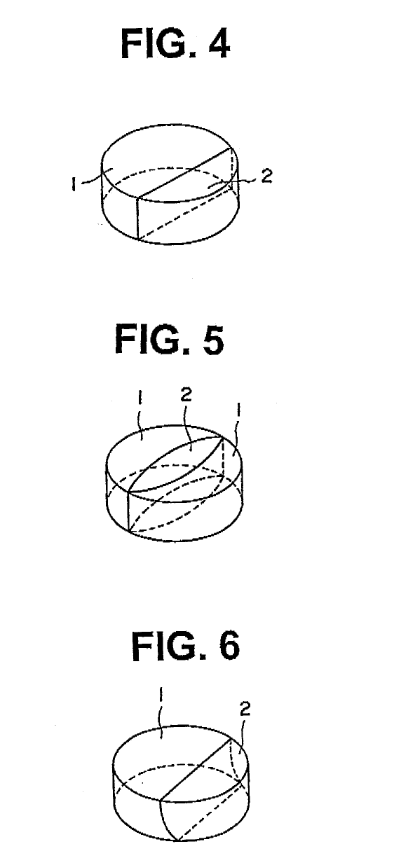

The evaporation source preferably is in the form of a pellet having a relative density of 80% to 90%. A typical pellet is illustrated in FIG. 7. The pellet can be produced at 50 to 2000 under pressure 800 to 1,000 kg/cm². Thus produced pellet can be subjected to degassing treatment.

If two or more evaporation sources are employed, these evaporation source portions can be placed adjacently to each other to form a pellet. See FIGS. 4 to 6 in the attached drawings. In FIG. 4, a mother component compound portion 1 is combined with an activator compound portion 2. In FIG. 5, an activator compound portion 2 is sandwitched between mother component compound portions 1. In FIG. 6, a mother component compound portion 1 is combined with an activator compound portion 2 under the condition that the activator compound portion 2 decreases in the bottom surface.

Otherwise, two or more pellet fragments are placed adjacently to each other in a dish of pellet form having two or more spaces. In FIG. 7, a pellet fragment of a mother component compound 1A is placed in one space and a pellet fragment of an activator compound 2A is placed in another space.

The pellet or a dish of pellet form is favorably employed as an evaporation source when the vapor deposition is carried out in a commercially available vapor deposition apparatus.

The vapor deposition can be performed in a commercially available vapor deposition apparatus according to the known procedure.

In the vapor deposition apparatus, the evaporation source and a substrate on which the phosphor film is to be deposited are set. The apparatus is then evacuated to give an inner pressure of 1×10⁻⁵ to 1×10⁻² Pa. An inert gas such as Ar gas or Ne gas may be incorporated into the apparatus. The substrate is placed perpendicularly to the direction in which the vapor comes out of the source.

In the vapor deposition apparatus, an electron beam generated by an electron gun is applied onto the vapor source. The accelerating voltage of electron beam preferably is in the range of 1.5 kV to 5.0 kV.

By applying the electron beam, the evaporation source is heated, vaporized, and deposited on the substrate. The deposition rate of the phosphor generally is in the range of 0.1 to 1,000 μm/min., preferably in the range of 1 to 100 μm/min. The electron beam may be applied twice or more to for two or more phosphor films. The substrate may be cooled or heated, if needed, during the deposition process, or may be subjected to beat treatment (annealing treatment) after the deposition process is complete.

The vapor deposition method used in the invention is not restricted to the electron beam-evaporating method, and various other methods such as resistance-heating method and sputtering method can be used.

In the above-described manner, the phosphor film in which the prismatic stimulable phosphor crystals are aligned almost perpendicularly to the substrate. Thus formed phosphor film comprises only the stimulable phosphor with no binder, and there are produced cracks extending the depth direction in the phosphor film.

The phosphor film preferably has a thickness of 100 μm to 1 mm, more preferably 200 to 700 μm.

It is preferred to provide a transparent protective film an the surface of phosphor film, so as to ensure good handling of the radiation image storage panel in transportation and to avoid deterioration. The protective film is preferably transparent. Further, for protecting the storage panel from chemical deterioration an physical damage, the protective film must be chemically stable, physically strong, and of high moisture proof. A moisture permeability of the protective film (at 25° C.) preferably is not higher than 300 g/m²·24 hr·μm.

The protective film can be provided by coating the stimulable phosphor film with a solution in which an organic polymer (e.g., cellulose derivatives, polymethyl methacrylate, fluororesins soluble in organic solvents) is dissolved in a solvent, by placing a beforehand prepared sheet for the protective film (e.g., a film of organic polymer such as polyethylene terephthalate, a transparent glass plate) on the phosphor film with an adhesive, or by depositing vapor of inorganic compounds on the phosphor film.

Various additives may be dispersed in the protective film. Examples of the additives include light-scattering fine particles (e.g., particles of magnesium oxide, zinc oxide, titanium dioxide and alumina), a slipping agent (e.g., powders of perfluoroolefin resin and silicone resin) and a crosslinking agent (e.g., polyisocyanate). The thickness of the protective film generally is in the range of about 0.1 to 20 μm (if the film is made of polymer material) or in the range of about 100 to 1,000 μm (if the film is made of inorganic material such as glass). For enhancing the resistance to stain, a fluororesin layer is preferably provided on the protective film. The fluororesin layer can be form by coating the surface of the protective film with a solution in which a fluororesin is dissolved or dispersed in an organic solvent, and drying the coated solution. The fluororesin may be used singly, but a mixture of the fluororesin and a film-forming resin can be employed. In the mixture, an oligomer having polysiloxane structure or perfluoroalkyl group can be further added. In the fluororesin layer, fine particle filler may be incorporated to reduce blotches caused by interference and to improve the quality of the resultant image. The thickness of the fluororesin layer is generally in the range of 0.5 to 20 μm. For forming the fluororesin layer, additives such as a crosslinking agent, a film-hardening agent and an anti-yellowing agent can be used. In particular, the crosslinking agent is advantageously employed to improve durability of the fluororesin layer.

Thus, the radiation image storage panel of the invention an be prepared. The storage panel of the invention way have known various structures. For example, in order to improve the sharpness of the resultant image, at least one of the films may be colored with a colorant which does not absorb the stimulated emission but the stimulating rays.

The process of the invention for reading radiation image information stored in the above-described radiation image storage panel is explained below by referring to the attached drawings.

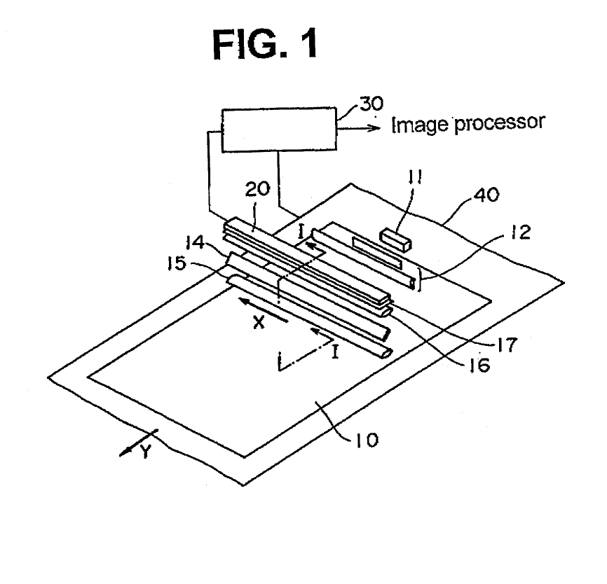

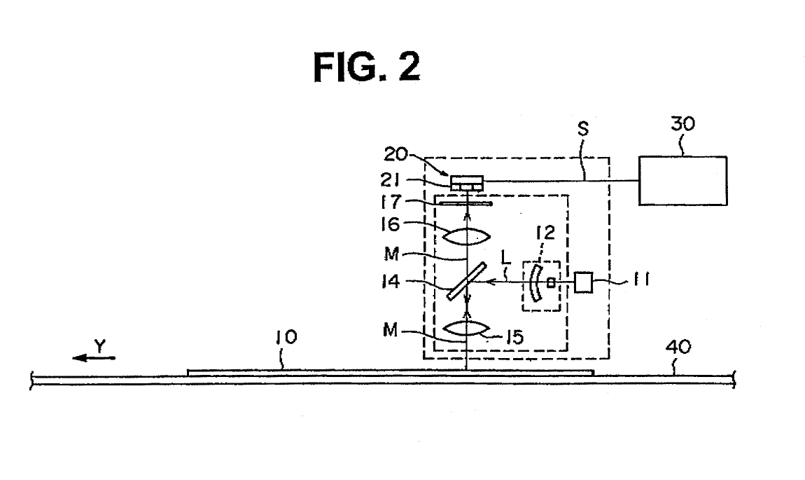

FIG. 1 is a sketch showing a radiation image information-reading apparatus for performing the process of the invention. FIG. 2 is a sectional view of the apparatus of FIG. 1 taken along the I-I line.

The storage panel 10 is beforehand exposed to radiation (such as X-rays) having passed through an object, and hence radiation image information of the object is recorded and stored in the storage panel 10. In consideration of storing efficiency of the radiation energy, the radiation such as X-rays are preferably applied almost perpendicularly to the storage panel 10 so that the incident direction may be parallel to the aligning direction of the prismatic phosphor crystals 13. The storage panel 10 is placed on the transferring belt 40 so that the phosphor film 12 would be placed upside. The transferring belt 40 moves in the direction shown by an arrow Y, and hence the storage panel 10 is transferred. The transferring speed of the storage panel 10 is identical with the moving speed of the belt 40, which is input into an image-reading means 30.

A broad area laser (hereinafter referred to as BLD) 41 linearly emits stimulating light L almost parallel to the surface of the panel 10. The stimulating light L passes through an optical system 12 comprising a collimator lens and a toric lens, and is thereby converted into parallel rays. The rays are then reflected by a dichroic mirror 14 placed at an angle of 45° to the storage panel 10. The dichroic mirror 14 reflects the stimulating rays, but transmits the stimulated emission. The rays reflected by the mirror 14 then advance perpendicularly to the storage panel 10, and pass through a distributed index lens array (an array of many distributed index lenses, hereinafter referred to as ‘first SELFOC lens array) 15 to be focused on the storage panel 10 linearly along the direction sham by an arrow X.

The linearly focused stimulating rays L are perpendicularly applied to the storage panel 10, and hence a stimulated emission M is emitted from the focused area. The emission M has an intensity according to the stored radiation image information.

The stimulated emission M is converted into parallel rays through the first SELFOC lens array 15, and pass through the dichroic mirror 14. The rays M then pass through a second SELFOC lens array 16, and are hence focused on photo-receiving faces of photoelectric converting elements 21 constituting a line sensor 20 placed just above the area on which the stimulating rays are focused. The line sensor 20 comprises many photoelectric converting elements 21 regularly arrayed in a line having at least the length of the area linearly exposed to the stimulating rays, and each element corresponds to one pixel. Since the line sensor 20 is placed right above the area on which the stimulating rays L are focused, the stimulated emission which almost perpendicularly comes can be efficiently collected. Further, the photo-receiving faces of the converting elements 21 are so small that the light-collecting efficiency is remarkably improved.

The stimulated emission M having passed through the second SELFOC lens array 16 is slightly contaminated with the stimulating rays L reflected by the surface of the storage panel 10, and hence the contaminating rays L are cut off with a stimulating ray-cutting filter 17. The filter 17 does not transmit the stimulating rays L but the stimulated emission M.

The stimulated emission M received by the converting elements 21 is photoelectrically converted into signals S, which are then it into the image-reading means 30. In the image-reading means 30, the signals S are processed on the basis of the moving speed of the transferring belt 40 to obtain image data according to the positions of the storage panel 10. Thus obtained image data are output on an image-processing apparatus (not shown).

The radiation image information-reading apparatus used in the invention is not restricted to the embodiment shown in FIGS. 1 and 2. Each part of the apparatus (such as the light source, the light-collecting optical system between the light source and the storage panel, the line sensor, the optical system between the storage panel and the line sensor) may have various known constitution.

In the above-described embodiment, since the prismatic phosphor crystals in the radiation image storage panel are aligned perpendicularly, the optical systems are designed so that the stimulating rays and the stimulated emission may be enter and come out, respectively, perpendicularly to the panel. However, it is not necessary that the optical systems be set strictly parallel to the aligning direction of the prismatic crystals. Further, in the case where the aligning direction of the prismatic crystals is inclined at a certain angle, the optical systems may be set so that the stimulating rays and the stimulated emission may be enter and come out, respectively, parallel or almost parallel to the inclined aligning direction.

As the line light source, a light source having a linear shape may be used. Further, a fluorescent lamp, a cold cathode fluorescent lamp and a LED (light-emitting diode) array can be also used. The line light source may emit stimulating light either continuously or intermittently in the form of pulses. For reducing possible noises, the stimulating light is preferably in the form of pulses with high power.

Examples of the line sensors include an amorphous silicon sensor, a CCD sensor, a CCD with back illuminator and MOS image sensor. The line sensor may consist of two or three rows of photoelectric converting elements, as well as a single row of the elements.

The radiation image storage panel is preferably transferred almost perpendicularly to the longitudinal direction of the line light source and the line sensor. However, as long as almost all of the surface of the panel is evenly exposed to the stimulating rays, the panel may be transferred diagonally or in zigzag.

In the above embodiment, the optical system between the storage panel and the line sensor is designed to form an image isometrically for simplifying the explanation. However, a magnifying or reducing optical system may be used. For increasing the light-collecting efficiency, the use of an isometrical or magnifying optical system is preferred.

Further, in the above embodiment, the optical path of the stimulating rays L and the stimulated emission M is partly overlapped to reduce the volume of the apparatus. However, the path of the stimulating rays L may be completely different from that of the emission M.

Furthermore, in the above embodiment, the radiation image information is read out while the radiation image storage panel is transferred. However, the information may be read out while not the storage panel but the line sensor is moved along the surface of the panel, or while both are moved to change their relative positions.

An image-processing apparatus, in which image data signals output from the radiation image information-reading means are subjected to various signal processing, may be installed. Further, an erasing means, in which radiation energy remaining in the panel after reading is adequately released, may be installed.

### EXAMPLES 1 to 13

### Two Source-evaporation

(1) Preparation of Evaporation Source

In a mortar, 100 g of powdery cesium bromide (CsBr, 0.47 mol) and powdery europium bromide (EuBrₓ, x=2.1) in an amount set forth in Table 1 were independently pulverized. Each of the pulverized materials was subjected to dehydrating-degassing treatment at 200° C. for 2 hours. Each of thus treated material was then pelletized at a pressure of 800 kg/cm² to give five pellets. The pellets were then subjected to degassing treatment at 150° C. for 2 hours in an evacuated chamber.

(2) Formation of Phosphor Film

A quartz substrate was washed successively with an aqueous alkaline solution, purified water, and isopropyl alcohol, and then mounted within a vapor deposition apparatus. In the vapor deposition apparatus, an appropriate number (dependent on the Eu concentration in the phosphor film to be deposited on the substrate) of CsBr pellet(s) and five EuBr_{2.1} pellets were placed in the predetermined sites of a revolving table. Subsequently, the apparatus was evacuated to reach 1×10⁻³ Pa.

In the apparatus, an electron beam from an electron gun (accelerating voltage: 4.0 kV) was applied onto the pellets alternately by revolving the table so as to deposit the stimulable CsBr:Eu phosphor on the substrate (heated to 200° C.) at a deposition rate of 15 μm/min.

After the deposition was complete, the inner pressure was returned to atmospheric pressure, and the substrate was taken out of the apparatus. On the substrate, a deposited film (thickness: approx. 450 μm) consisting of prismatic phosphor crystals (each crystal having the width of approx. 8 μm and the length of approx. 450 μm) aligned densely and perpendicularly was formed.

Thus, a radiation image storage panel of the invention having a substrate and a deposited phosphor layer was prepared.

### Comparison Examples 1 and 2

### Two Source-evaporation

The procedures of the above-mentioned Examples were repeated except for using EuBr_{2.1} in an amount set forth in Table 1, to prepare a radiation image storage panel for comparison.

TABLE 1

| | |
|---|---|
| Example | EuBr_{2.1} |

| No. | Amount (g) | Mol. |
|---|---|---|
| Example 1 | 0.0150 | 4.70 × 10⁻⁵ |
| Example 2 | 0.0451 | 1.41 × 10⁻⁴ |
| Example 3 | 0.1052 | 3.29 × 10⁻⁴ |
| Example 4 | 0.1503 | 4.70 × 10⁻⁴ |
| Example 5 | 0.3005 | 9.40 × 10⁻⁴ |
| Example 6 | 0.4508 | 1.41 × 10⁻³ |
| Example 7 | 0.7513 | 2.35 × 10⁻³ |
| Example 8 | 1.0518 | 3.29 × 10⁻⁵ |
| Example 9 | 1.5026 | 4.70 × 10⁻³ |
| Example 10 | 4.5078 | 1.41 × 10⁻² |
| Example 11 | 15.0259 | 4.70 × 10⁻² |
| Example 12 | 45.0777 | 1.41 × 10⁻¹ |
| Example 13 | 150.2589 | 4.70 × 10⁻¹ |
| Com. Ex. 1 | 0.0105 | 3.29 × 10⁻⁵ |
| Com. Ex. 2 | 300.5177 | 9.40 × 10⁻¹ |

### Examples 14 to 16

### One Source-evaporation

(1) Preparation of Evaporation Source

A powder of CsBr (100 g, 0.47 mol.) and a powder of EuBr_{2.1} in an amount set forth in Table 2 were mixed and stirred for 15 minutes in a vibrating apparatus. The powdery mixture was then heated to 525° C. for 2 hours for firing. The fired powder was dehydrated and degassed at 200° C. in an evacuated chamber. The powder was then compressed at a pressure of 800 kg/cm² are to produce five pellets. Each pellet was subjected to degassing treatment at 150° C. for 2 hours in an evacuated chamber.

(2) Formation of Phosphor Film

The procedures of the aforementioned Examples were repeated except for employing the above-produced pellets, to deposit on a quartz substrate an europium activated cesium bromide phosphor film consisting of prismatic crystals (film thickness: approx. 450 μm). Thus, radiation image storage panels of the invention were prepared.

TABLE 2

| | |
|---|---|
| Example | EuBr_{2.1} |

| No. | Amount (g) | Mol. |
|---|---|---|
| Example 14 | 0.3361 | 1.05 × 10⁻⁵ |
| Example 15 | 37.0671 | 1.16 × 10⁻⁴ |
| Example 16 | 79.4295 | 2.48 × 10⁻⁴ |

### Evaluation of Radiation Image Storage Panel

The radiation image storage panels were examined in their shapes and conditions of prismatic phosphor crystals and film, surface conditions and fixation to substrate of the phosphor film, and sensitivity, in the following manners.

(1) Shapes of Prismatic Phosphor Crystals

Nodes and agglutinated portions of crystals were observed microscopically. Prismatic phosphor crystals having neither node nor agglutination is preferred.

(2) Conditions of Prismatic Phosphor Film

The arrangement of prismatic phosphor crystals was examined microscopically. Accurately aligned prismatic crystals were preferred.

(3) Surface Conditions of Phosphor Film

Roughness of the film surface was viewed. The surface roughness reflects the growth of prismatic crystals, presence of defective crystals, and uniformness of the surface material. Smooth surface on the phosphor film is preferred.

(4) Fixation of Phosphor Film

Resistance to peeling of the phosphor film from the substrate was examined. High resistance is preferred.

The results of examinations are expressed by the following marks:

AA: Prominently good, A: Good, B: Not good, C: Slightly bad

(5) Sensitivity

Each radiation image storage panel was exposed to X-rays (voltage: 80 kVp, current: 30 mA) and subsequently scanned with He—Ne laser beam. The stimulated emission was detected to examine the sensitivity from the luminance of stimulated emission. The sensitivity is expressed in terms of a relative value.

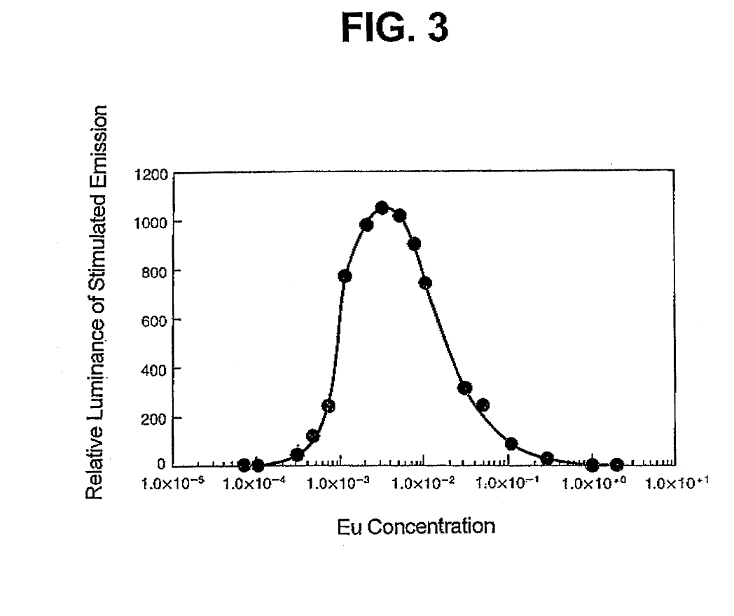

The results are set forth in Table 3 and illustrated graphically in FIG. 3.

TABLE 3

| Example | Eu. concen- | Prismatic crystals | | Phosphor film | |
|---|---|---|---|---|---|
| No. | tration (mol.) | Shape | Condition | Surface | Fixation |
| Com. 1 | 7.00 × 10⁻⁵ | AA | AA | A | A |
| Com. 2 | 2.01 | C | B | B | C |
| Ex. 1 | 1.05 × 10⁻⁴ | AA | AA | A | AA |
| Ex. 2 | 2.97 × 10⁻⁴ | AA | AA | A | AA |
| Ex. 3 | 7.01 × 10⁻⁴ | AA | AA | A | AA |
| Ex. 4 | 1.12 × 10⁻³ | AA | AA | A | AA |
| Ex. 5 | 1.99 × 10⁻³ | AA | AA | A | AA |
| Ex. 6 | 3.00 × 10⁻³ | AA | AA | AA | A |
| Ex. 7 | 4.86 × 10⁻³ | AA | AA | A | A |
| Ex. 8 | 7.10 × 10⁻³ | A | A | AA | A |
| Ex. 9 | 1.01 × 10⁻² | A | A | A | A |
| Ex. 10 | 3.01 × 10⁻² | A | B | A | A |
| Ex. 11 | 1.05 × 10⁻¹ | B | B | A | A |
| Ex. 12 | 2.96 × 10⁻¹ | B | B | B | B |
| Ex. 13 | 1.02 | B | B | B | B |
| Ex. 14 | 4.57 × 10⁻⁴ | A | A | AA | A |
| Ex. 15 | 5.04 × 10⁻² | A | A | B | B |
| Ex. 16 | 1.08 × 10⁻² | B | B | B | B |

### Example 17

The procedures of Example 1 were repeated to deposit a stimulable CsBr:0.003Eu phosphor film on a quartz substrate.

On the phosphor film was formed a protective film in the following manner.

The following materials were mixed for 20 hours in a ball mill using zirconia balls (diameter: 3 mm).

| | | |
|---|---|---|
| Film-forming resin (fluorine-containing copolymer, | 40 | g |
| Lumifuron LF504X, 30% xylene solution, | | |
| available from Asahi Glass Works Co., Ltd.) | | |
| Organic fine white powder (melamine-formaldehyde | 28.4 | g |
| resin powder (Eposter-S6., available from | | |
| Nippon Catalyst Co., Ltd.) | | |
| Dispersant (aluminum coupling agent, Plainact AL-M, | 0.5 | g |
| available from Ajinomoto Co., Ltd.) | | |
| Methyl ethyl ketone | 200 | g |

To the resulting dispersion was added additional 360 g of the film-forming resin solution, and then they were mixed for 4 hours. To the resulting mixture was further added the following materials, and they were mixed to give a dispersion for the protective film.

| | | |
|---|---|---|
| Reactive silicone (silicone macromonomer, Siraplain | 5.6 | g |
| FM-DA26, available from Chisso Co., Ltd.) | | |
| Cross-linking, agent (polyisocyanate, Sumijul N3300, | 22.2 | g |
| solid content 100%, available from Sumitomo | | |
| Bayer Urethane Co., Ltd.) | | |
| Catalyst (dibutyltin laurate, KS1260, available | 1.4 | mg |
| from Kyodo Chemicals, Co., Ltd.) | | |
| Methyl ethyl ketone | 800 | g |

The dispersion was coated on the phosphor film using a slit coater, and the coated film was heated to 120° C. for 20 minutes to dry and cure the coated composition to form a protective film (thickness: 6 μm) on the phosphor film.

The surrounding edges of the substrate and phosphor film were coated with the following resin composition.

| | | |
|---|---|---|
| Film-forming resin (fluorine-containing copolymer, | 40 | g |
| Lumifuron LF504X, 30% xylene solution, | | |
| available from Asahi Glass Works Co., Ltd.) | | |
| Cross-linking agent (polyisocyanate, Colonate HK, | 22.2 | g |
| available from Nippon Polyurethane Co., Ltd.) | | |
| Catalyst (dibutyltin laurate, KS1260, available | 1.4 | mg |
| from Kyodo (Chemicals, Co., Ltd.) | | |
| Anti-yellowing agent (epoxy resin, Epikote #1001, | 0.6 | g |
| solid, available from Yuka-Shell Epoxy Co., Ltd. | | |
| Slipping agent (reactive silicone, Siraplain FM-DA26, | 0.2 | g |
| available from Chisso Co., Ltd.) | | |
| Methyl ethyl ketone | 15 | g |

The resin composition was coated over the edges and dried at room temperature to form an edge coat of approx. 25 μm thick.

### Example 18

### Preparation of CsBr:Eu Phosphor Film

(1) Preparation of Evaporation Source

In a mortar, powdery cesium bromide (CsBr) and powdery europium bromide (EuBrₓ, x=2.2) were independently pulverized. Each of the pulverized material was then pelletized at a pressure of 800 kg/cm² to give a pellet. Each pellet was were then subjected to degassing treatment at 150° C. for 2 hours in an evacuated chamber. Each of the degassed pellets was cut to give a pellet fragment, and placed in a dish having divided spaces (see FIG. 7). In the dish, a weight ratio of CsBr/EuBrₓ was 100 g/1.8404 g.

(2) Formation of Phosphor Film

A quartz substrate was mounted within a vapor deposition apparatus. In the vapor deposition apparatus, the pellet was placed in the predetermined site. Subsequently, the apparatus was evacuated to reach 6.7×10⁻³ Pa.

In the apparatus, an electron beam from an electron gun (accelerating voltage: 4.0 kV) was applied onto the pellet for 20 minutes to deposit the stimulable CsBr:Eu phosphor on the substrate (heated to 250° C.) at a deposition rate of 25 μm/min.

After the deposition was complete, the inner pressure was returned to atmospheric pressure, and the substrate was taken out of the apparatus. On the substrate, a deposited film (thickness: approx. 450 μm) consisting of prismatic phosphor crystals (each crystal having the width of approx. 3 μm and the length of approx. 450 μm) aligned densely and perpendicularly was formed.

Thus, a radiation image storage panel having a substrate and a deposited phosphor layer was prepared.

### Example 19

### Preparation of CsBr:Eu Phosphor Film

The procedures of Example 18 were repeated except for using an evaporation source of CsBr(100 g)/EuBrₓ(100 g) and controlling the conditions of electron beam application area to give a radiation image storage panel.

### Example 20

### Preparation of CsBr:Eu Phosphor Film

The procedures of Example 18 were repeated except for using an evaporation source of CsBr(100 g)/EuBrₓ(100 g) and controlling the conditions of electron beam application pattern to give a radiation image storage panel.

### Comparison Example 3

### Preparation of CsBr:Eu Phosphor Film

(1) Preparation of Evaporation Source

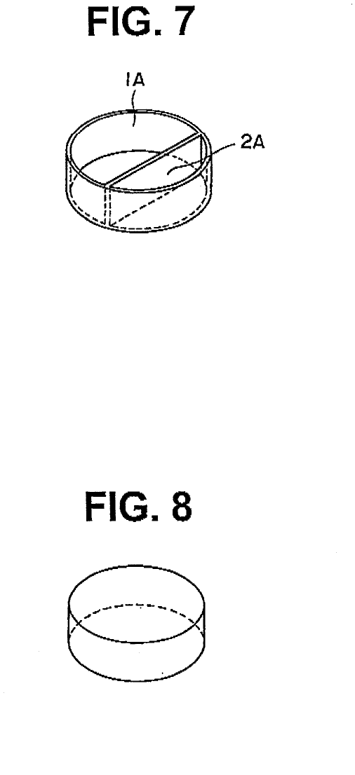

In a mortar, 100 g of powdery cesium bromide (CsBr, 0.47 mol) and 1.8404 g of powdery europium bromide (EuBrₓ, x=2.2, 5.6×10⁻³ mol) were pulverized. The pulverized material was stirred in a shaking apparatus for 15 minutes. Thus treated material was then placed in a furnace. The furnace was evacuated for 3 minutes. The material was fired in the furnace at 525° C. for 2 hours. After the firing was complete, the furnace was evacuated for 15 minutes to cool the fired material. The cooled material was pulverized in a mortar and compressed at 800 kg/c² to give a pellet having the shape of FIG. 8. The pellet was then degassed at 150° C. for 2 hours.

(2) Formation of Phosphor Film

The procedures of Example 18 were repeated to form a stimulable CsBr:Eu phosphor film (thickness: 450 μm on the substrate.

### Reference Example 1

### Two Source-evaporation

(1) Preparation of Evaporation Source

In a mortar, 100 g of powdery cesium bromide (CsBr, 0.47 mol) and 1.8404 g of powdery europium bromide (EuBrₓ, x=2.2, 5.6×10⁻³ mol) were independently pulverized. Each of the pulverized materials was compressed at 800 kg/cm² to give a pellet having the shape of FIG. 8. The resulting two pellets were was then degassed at 150° C. for 2 hours.

(2) Formation of Phosphor Film

A quartz substrate was mounted within a vapor deposition apparatus. In the vapor deposition apparatus, each of the two pellets was placed in the predetermined site. Subsequently, the apparatus was evacuated to reach 6.7×10⁻³ Pa.

In the apparatus, an electron beam from an electron gun (accelerating voltage: 4.0 kV) was applied onto both of the pellets for 20 minutes to deposit the stimulable CsBr:Eu phosphor on the substrate (heated to 250° C.) at a deposition rate of 25 μm/min.

After the deposition was complete, the inner pressure was returned to atmospheric pressure, and the substrate was taken out of the apparatus. On the substrate, a deposited film (thickness: approx. 450 μm) consisting of prismatic phosphor crystals (each crystal having the width of approx. 3 μm and the length of approx. 450 μm) aligned densely and perpendicularly was formed.

Thus, a radiation image storage panel having a substrate and a deposited phosphor layer was prepared.

### Example 21

### Preparation of KCl:Eu Phosphor Film

The procedures of Example 18 were repeated except for using a combined pellet of 100 g of potassium chloride (KCl, 1.34 mol.) and 0.5254 g of europium bromide (EuBr_{2.2}, 1.60×10⁻³ mol), to deposit a KCl:Eu phosphor film on the substrate.

### Comparison Example 4

### Preparation of KCl:Eu Phosphor Film

The procedures of Comparison Example 3 were repeated except for mixing 100 g of KCl and 0.5254 g of EuBr_{2.2}, and firing the mixed materials at 650° C. for 2 hours to prepare a single pellet. The single pellet was employed for depositing a KCl:Eu phosphor film on the substrate.

### Example 22

### Preparation of NaCl:Cu Phosphor Film

The procedures of Example 18 were repeated except for using a combined pellet of 100 g of sodium chloride (KCl, 1.71 mol) and 0.1694 g of copper chloride (CuCl, 1.71×10⁻³ mol), to deposit a NaCl:Cu phosphor film on the substrate.

### Comparison Example 5

### Preparation of NaCl:Cu Phosphor Film

The procedures of Comparison Example 3 were repeated except for mixing 100 g of NaCl and 0.1694 g of CuCl, and firing the mixed materials at 650° C. for 2 hours to prepare a single pellet. The single pellet was employed for depositing a NaCl:Cu phosphor film on the substrate.

### Example 23

### Preparation of RbBr:Eu Phosphor Film

The procedures of Example 18 were repeated except for using a combined pellet of 100 g of rubidium bromide (RbBr, 1.61 mol) and 0.2370 g of europium bromide (EuBr_{2.2}, 7.23×10⁻⁴ mol) ,to deposit a RbBr:Eu phosphor film on the substrate.

### Comparison Example 6

### Preparation of RbBr:Eu Phosphor Film

The procedures of Comparison Example 3 were repeated except for mixing 100 g of RbBr and 0.2370 g of EuBr_{2.2}, and firing the mixed materials at 575° C. for 2 hours to prepare a single pellet. The single pellet was employed for depositing a RbBr:Eu phosphor film on the substrate.

### Example 24

### Preparation of RbBr:Tl Phosphor Film

The procedures of Example 18 were repeated except for using a combined pellet of 100 g of rubidium bromide (RbBr, 1.61 mol) and 0.1720 g of thallium bromide (TlBr, 6.05×10⁻⁴ mol) to deposit a RbBr;Tl phosphor film on the substrate.

### Comparison Example 7

### Preparation of RbBr:Tl Phosphor Film

The procedures of Comparison Example 3 were repeated except for mixing 100 g of RbBr and 0.1720 g of TlBr, and firing the mixed materials at 575° C. for 2 hours to prepare a single pellet. The single pellet was employed for depositing a RbBr:Tl phosphor film on the substrate.

### Evaluation of Radiation Image Storage Panel

The radiation image storage panels were examined in their shapes and conditions of prismatic phosphor crystals and film, surface conditions and fixation to substrate of the phosphor film, and sensitivity, in the manners set forth before.

The results are set forth in Table 4.

TABLE 4

| Example | Sensitivity | Prismatic crystals | | Phosphor film | |
|---|---|---|---|---|---|
| No. | (relative value) | Shape | Condition | Surface | Fixation |

CsBr: Eu phosphor

| | | | | | |
|---|---|---|---|---|---|
| Ex. 18 | 23 | AA | AA | A | AA |
| Ex. 19 | 24 | AA | AA | A | AA |
| Ex. 20 | 22 | AA | AA | A | AA |
| Com. Ex. 3 | 1 | AA | AA | A | AA |
| Ref. Ex. 1 | 25 | AA | AA | AA | AA |

KCl: Eu phosphor

| | | | | | |
|---|---|---|---|---|---|
| Ex. 21 | 2.3 | AA | A | A | AA |
| Com. Ex. 4 | 1 | A | A | A | A |

NaCl: Cu phosphor

| | | | | | |
|---|---|---|---|---|---|
| Ex. 22 | 3.7 | A | A | A | AA |
| Com. Ex. 5 | 1 | A | A | C | A |

RbBr: Eu phosphor

| | | | | | |
|---|---|---|---|---|---|
| Ex. 23 | 1.7 | AA | A | A | AA |
| Com. Ex. 6 | 1 | AA | A | A | AA |

RbBr: Tl phosphor

| | | | | | |
|---|---|---|---|---|---|
| Ex. 24 | 1.5 | AA | A | A | A |
| Com. Ex. 7 | 1 | A | A | A | B |

It was confirmed that the combined pellet comprising a mother component material portion and an activator component potion gives a satisfactory phosphor film, which is almost the same given by using two independent pellets for the mother component material and activator component material. The combined pellet is advantageous in the mounting operation and further in that a commercially available vapor deposition apparatus having a single pellet-receiving site.

What is claimed is:

1. A radiation image storage panel comprising a substrate and a phosphor film which has cracks extending in a depth direction thereof and is formed by vapor deposition, wherein the phosphor film comprises an europium activated alkali metal halide phosphor having the formula (I):
M^{I}X.bM^{II}X′₂.cM^{III}X^{″}₃:zEu (I)
in which M^{I} is at least one alkali metal element selected from the group consisting of Cs, Li, Na, K and Rb; M^{II} is at least one alkaline earth metal element or divalent metal element selected from the group consisting of Be, Mg, Ca, Sr, Ba, Ni, Cu, Zn and Cd; M^{III} is at least one rare earth element or trivalent metal element selected from the group consisting of Sc, Y, La, Ce, Pr, Nd, Pm, Sm, Eu, Gd, Th, Dy, Ho, Er, Tm, Yb, Lu, Al, Ga and In; each of X, X′ and X″ independently is at least one halogen selected from the group consisting of F, Cl, Er and I; and a, b, c and z are numbers satisfying the conditions of 0≦b≦0.5, 0≦c≦0.5 and 0.0001≦z≦0.01, respectively.

2. The radiation image storage panel of claim 1, wherein z for the formula (I) satisfies the condition of 0.0005≦z≦0.007.

3. The radiation image storage panel of claim 2, wherein z for the formula (I) satisfies the condition of 0.001≦z≦0.007.

4. The radiation image storage panel of claim 3, wherein z for the formula (I) satisfies the condition of 0.003≦z≦0.005.

5. A radiation image storage panel comprising a substrate and a phosphor film which has cracks extending in a depth direction thereof and is formed by vapor deposition, wherein the phosphor film comprises an europium activated cesium bromide phosphor having the formula (II):
CsBr.aM^{I}X.bM^{II}X′₂.cM^{III}X″₃:zEu (II)
in which M^{I} is at least one alkali metal element selected from the group consisting of Li, Na, K and Rb; M^{II} is at least one alkaline earth metal element or divalent metal element selected from the group consisting of Be, Mg, Ca, Sr, Ba, Ni, Cu, Zn and Cd; M^{III} is at least one rare earth element or trivalent metal element selected from the group consisting of Sc, Y, La, Ce, Pr, Nd, Pm, Sm, Eu, Gd, Tb, Dy, Ho, Er, Tm, Yb, Le, Al, Ga and In; each of X, X′ and X″ independently is at least one halogen selected from the group consisting of F, Cl, Br and I; and a, b, c and z are numbers satisfying the conditions of 0≦a≦0.5, 0≦b≦0.5, 0≦c≦0.5 and 0.0001≦z≦0.01, respectively.

6. The radiation image storage panel of claim 5, wherein z for the formula (II) satisfies the condition of 0.001≦z≦0.007.

7. The radiation image storage panel of claim 6, wherein z for the formula (II) satisfies the condition of 0.003≦z≦0.005.

8. A radiation image storage panel comprising a substrate and a phosphor film which has cracks extending in a depth direction thereof and is formed by vapor deposition, wherein the phosphor film comprises an europium activated cesium bromide phosphor containing an europium element at an atomic ratio in the range of 0.0001 to 0.01 in terms of Eu/Cs.

9. The radiation image storage panel of claim 8, wherein the atomic ratio is in the range of 0.001 to 0.007.

10. The radiation image storage panel of claim 9, wherein the atomic ratio is in the range of 0.003 to 0.005.

11. A process for reading radiation image information comprising the steps of:
moving in one direction the radiation image storage panel of claim 1 on which radiation image information is recorded and stored, in relation to a line sensor which comprises plural photoelectric converting elements arranged linearly and which is placed over the convex surfaces of the aligned prismatic phosphors of the storage panel on a line extending from the end of the convex surface of the aligned prismatic crystal in the same direction, under such condition that the line sensor moves on a plane parallel to the storage panel, while the phosphor film of the storage panel is scanned with stimulating rays in a direction which is different from the direction of the movement of the storage panel and the stimulating lays are applied onto the phosphor film approximately parallel to the aligning direction of the prismatic phosphor crystals in the phosphor film;
detecting an emission emitting from the phosphor film of the storage panel by the line sensor, so as to photoelectrically convert the emission to an electric signal;
detecting an electric signal of the movement of the storage panel in relation to the line sensor; and
comparing the signal of the emission and the signal of the movement of the storage panel to produce a radiation image information in the form of electric signals.

12. A method for forming on a substrate a phosphor film which comprises an europium activated cesium bromide phosphor containing an europium element at an atomic ratio in the range of 0.0001 to 0.01 in terms of Eu/Cs by vapor deposition.

13. The method of claim 12, wherein the vapor deposition is performed by heating an evaporation source of the phosphor with an electron beam.

14. The method of claim 12, wherein the evaporation source is divided into plural evaporation source portions, one of which comprises an europium compound and other of which comprises a cesium compound.

15. The method of claim 14, wherein the plural evaporation source portions are placed adjacently to each other forming one unit.

16. A method for forming on a substrate a phosphor film of a stimulable phosphor comprising a mother component and an activator component by vapor deposition utilizing plural evaporation source portions one of which comprises the activator component source and other of which comprises a mother component source and which are placed adjacently to each other for one unit.

17. The method of claim 16, herein the vapor deposition is performed by heating the evaporation source portions of the phosphor with an electron beam.

18. A method for forming on a substrate a phosphor film of a stimulable phosphor comprising at least two metal elements by vapor deposition utilizing plural evaporation source portions one of which comprises one metal element source and other of which comprises other metal source and which are placed adjacently to each other forming one unit.

19. The method of claim 18, wherein the vapor deposition is performed by heating the evaporation source portions of the phosphor with an electron beam.
